(19) United States
(12) Patent Application Publication
(10) Pub. No.: US 2026/0158416 A1
(43) Pub. Date: Jun. 11, 2026

(54) METHOD AND DEVICE FOR SIMULATED MOVING BED EXTRACTION BY LITHIUM ADSORPTION

(71) Applicant: IFP Energies nouvelles, Rueil-Malmaison (FR)

(72) Inventors: Guillaume BLANCKE, Rueil-Malmaison Cedex (FR); Damien LEINEKUGEL-LE-COCQ, Rueil-Malmaison Cedex (FR); Philibert LEFLAIVE, Rueil-Malmaison Cedex (FR)

(73) Assignee: IFP Energies nouvelles, Rueil-Malmaison (FR)

(21) Appl. No.: 18/723,253

(22) PCT Filed: Dec. 13, 2022
(86) PCT No.: PCT/EP2022/085706

§ 371 Date: Jun. 21, 2024

(30) Foreign Application Priority Data
Dec. 23, 2021 (FR) FR2114361

(51) Int. Cl. B01D 15/18; B01J 20/08; C22B 3/24; C22B 26/12

(52) U.S. Cl. CPC B01D 15/1828; B01D 15/1842; B01D 15/185; B01J 20/08; C22B 3/24; C22B 26/12

(57) ABSTRACT

Process and apparatus for simulated moving-bed adsorption extraction of lithium, wherein at least one column (Cᵢ) is fed with a feed (F) comprising lithium and with a desorbent (D) and wherein an extract (E) and a raffinate (R) are withdrawn from the column (Cᵢ), said column (Cᵢ) comprising a solid adsorbent (Aᵢ) comprising a lithiated aluminum oxyhydroxide and/or a lithiated aluminum hydroxide being interconnected in a closed loop, the feeding and withdrawal points of the column (Cᵢ) being shifted over time by a value corresponding to a predetermined amount of solid adsorbent having a switching time, and defining a plurality of operating zones of the column (Cᵢ), in particular the following main zones: a zone I of lithium desorption; a zone II of desorption of compounds other than lithium; and a zone III of lithium adsorption.

### TECHNICAL FIELD

The present invention relates to the field of lithium separation by adsorption phenomena. The present invention also relates to the field of simulated moving-bed separation.

### PRIOR ART

Lithium ions coexist with massive amounts of metals such as alkali metals and alkaline earth metals, boron, and sulfates, in saline solutions such as brines in particular. They accordingly need to be extracted from these saline solutions economically and selectively. Specifically, the chemical properties of lithium and the alkali metals, preferably sodium (Na) and potassium (K), and the alkaline earth metals, preferably magnesium (Mg), calcium (Ca), and strontium (Sr), make it difficult to separate these elements.

Solid materials based on aluminum oxyhydroxide AlO(OH) and/or aluminum hydroxide Al(OH)₃ are known for their use as adsorbent in adsorption/desorption phenomena of lithium ions and in processes for the adsorption extraction of lithium from saline solutions in particular. Advantageously, said materials allow the intercalation of lithium atoms in their structure and thus the extraction of lithium from a feed by adsorption and the production of a lithium-enriched extract by desorption using a desorbent.

Patent application FR 3053264 A1 describes in particular a process for the adsorption extraction of lithium from saline solutions, said process employing a solid material of formula (LiCl)ₓ·2Al(OH)₃·nH2O, where n is between 0.01 and 10 and x is between 0.4 and 1, for the extraction of lithium from saline solutions.

Although the use of such materials makes it possible for acceptable levels of lithium purification to be obtained, the production of lithium by adsorption phenomena can be improved.

### SUMMARY OF THE INVENTION

In the context described above, a first object of the present description is to overcome the problems of the prior art and to provide a process and an apparatus for the adsorption extraction of lithium that makes it possible to increase the concentration of lithium in the extract. The high concentration of lithium in the extract makes it possible in particular to reduce the amount of water to be evaporated or separated later on in the process, thus simplifying the equipment of the extraction apparatus and bringing significant energy savings.

A second object of the present description is to obtain a very low content of impurities such as calcium, magnesium or boron in the extract, thereby making it possible to limit or even eliminate the need for lithium purification steps downstream of the adsorption extraction.

A third object of the present description is to limit the consumption of desorbent in the process in order to limit its environmental impact.

Advantageously, the applicant had identified that lithiated solid materials based on aluminum oxyhydroxide AlO(OH) and/or aluminum hydroxide Al(OH)₃ were suitable for the adsorption extraction of lithium in a simulated moving-bed or simulated countercurrent separation process and apparatus.

According to a first aspect, the abovementioned objects, and also other advantages, are obtained by a simulated moving-bed lithium adsorption extraction process comprising the following step:
feeding at least one column with at least one feed comprising lithium and with a desorbent, and withdrawing at least one extract and at least one raffinate from the column, the at least one column comprising a solid adsorbent comprising at least one lithiated aluminum oxyhydroxide AlO(OH) and/or at least one lithiated aluminum hydroxide Al(OH)₃, the at least one column being interconnected in a closed loop, the feeding and withdrawal points of the at least one column being shifted over time by a value corresponding to a predetermined amount of solid adsorbent having a switching time, and defining a plurality of operating zones of the column, in particular the main zones below designated numerically as follows:
a zone I of lithium desorption between a point of injection of the desorbent and a point of withdrawal of the extract;
a zone II of desorption of alkali metals other than lithium and/or of alkaline earth metals between the point of withdrawal of the extract and a point of injection of the lithium-containing feed;
a zone III of lithium adsorption between the point of injection of the feed and a point of withdrawal of the raffinate; and
a zone IV between the point of withdrawal of the raffinate and the point of injection of the desorbent.

According to one or more embodiments, the at least one column comprises a plurality of columns or adsorbers interconnected in a closed loop, the feeding and withdrawal points of the columns or adsorbers being shifted over time by a value corresponding to a column or an adsorber.

According to one or more embodiments, the plurality of columns or adsorbers comprises at least 4 columns or adsorbers, preferably between 4 and 24 columns or adsorbers, preferably between 8 and 21 columns or adsorbers, for example between 12 and 15 columns or adsorbers.

According to one or more embodiments, the solid adsorbent is distributed in zones I to IV according to configurations referred to as type a/b/c/d configurations, that is to say the distribution of the solid adsorbent relative to the total amount of solid adsorbent is as follows:
a is the amount of solid adsorbent in zone I;
b is the amount of solid adsorbent in zone II;
c is the amount of solid adsorbent in zone III; and
d is the amount of solid adsorbent in zone IV,
   in which process:

$$- a = 43 \% \pm 9 \% ;$$

$$- b = 29 \% \pm 6 \% ;$$

$$- c = 14 \% \pm 3 \% ; and$$

$$- d = 14 \% \pm 3 \% .$$

According to one or more embodiments, the at least one column comprises a plurality of beds of solid adsorbent interconnected in a closed loop and separated by plates, the feeding and withdrawal points in the plates of the column being shifted over time by a value corresponding to a bed of adsorbent.

According to one or more embodiments, the at least one column comprises at least 4 beds of solid adsorbent, preferably between 4 and 24 beds of solid adsorbent, preferably between 8 and 21 beds of solid adsorbent, for example between 12 and 15 beds of solid adsorbent.

According to one or more embodiments, the beds of solid adsorbent are distributed in zones I to IV according to configurations referred to as type a/b/c/d configurations, that is to say the distribution of the beds of solid adsorbent is as follows:
a is the number of beds in zone I;
b is the number of beds in zone II;
c is the number of beds in zone III; and
d is the number of beds in zone IV,
   in which process:

$$- a = ( t * 0.43 ) * ( 1 \pm 0.20 ) ;$$

$$- b = ( t * 0.29 ) * ( 1 \pm 0.20 ) ;$$

$$- c = ( t * 0.14 ) * ( 1 \pm 0.20 ) ; and$$

$$- d = ( t * 0.14 ) * ( 1 \pm 0.20 ) ,$$

in which process t (the number of beds) is a natural integer between 4 and 24, preferably between 8 and 21, for example between 12 and 15, beds of solid adsorbent.

According to one or more embodiments, a portion of the extract or a stream obtained by concentrating and/or purifying said extract is fed to zone II, preferably to a central portion of zone II, very preferably substantially in the middle of zone II, in particular to improve the concentrating of the extract.

According to one or more embodiments, the solid adsorbent comprises and preferably consists of lithiated bayerite and/or lithiated boehmite.

According to one or more embodiments, the solid adsorbent comprises between 0.1% by weight and 5% by weight of the element lithium, preferably in the form of LiCl, relative to the total weight of the solid adsorbent.

According to one or more embodiments, the solid adsorbent comprises and preferably consists of a solid material of formula (LiCl)_{x·}2Al(OH)₃·nH₂O, where n is between 0.01 and 10 and x is between 0.4 and 1.

According to one or more embodiments, the desorbent is selected from the group consisting of water, lithiated water, and brine, preferably water.

According to one or more embodiments, the desorbent comprises between 0 g/L and 1 g/L of the element lithium, preferably in the form of LiCl, relative to the total weight of the desorbent.

According to one or more embodiments, the feed comprises at least 0.1 g/L by weight of the element lithium, preferably in the form of LiCl, relative to the total weight of the feed.

According to one or more embodiments, the steps of the process are carried out at a temperature (e.g. temperature in the solid adsorbent) of between 0° C. and 120° C. and preferably between 5° C. and 100° C., more preferably between 15° C. and 80° C., very preferably between 40° C. and 80° C., in particular in order to promote accelerated penetration of the solid adsorbent.

Advantageously, the steps of the process are carried out at a pressure (e.g. pressure in the solid adsorbent) that is controlled such that the liquid phase is maintained at all points in the process according to the invention. According to one or more embodiments, the pressure in the beds of solid adsorbent is between 0.09 MPa and 5 MPa, preferably between 0.095 MPa and 3.5 MPa, preferably between 0.1 MPa and 2.5 MPa.

According to one or more embodiments, the cycle duration is at least 20 minutes, preferably at least 40 minutes, such as between 1 hour and 10 hours. Preferably, the cycle duration is between 2 hours and 8 hours.

According to one or more embodiments, the ratio of the volume flow rate of the desorbent to the volume flow rate of the feed is less than 1, preferably less than 0.5, preferably less than 0.2, very preferably less than 0.1.

According to one or more embodiments, the ratio of the volume flow rate of the desorbent to the volume flow rate of the feed is between 0.01 and 1.0, preferably between 0.02 and 0.5, very preferably between 0.06 and 0.1.

According to a second aspect, the abovementioned objects, and also other advantages, are obtained by a simulated moving-bed lithium adsorption extraction apparatus comprising the following elements:
at least one column suitable for being fed with at least one feed comprising lithium and with a desorbent and for the withdrawal of at least one extract and at least one raffinate from the column, the at least one column comprising a solid adsorbent comprising at least one lithiated aluminum oxyhydroxide AlO(OH) and/or at least one lithiated aluminum hydroxide Al(OH)₃, the at least one column being interconnected in a closed loop, the feeding and withdrawal points of the at least one column being shifted over time by a value corresponding to a predetermined amount of solid adsorbent having a switching time, and a plurality of column operating zones being defined, in particular the main zones below designated numerically as follows:
a zone I of lithium desorption between a point of injection of the desorbent and a point of withdrawal of the extract;
a zone II of desorption of alkali metals other than lithium and/or of alkaline earth metals between the point of withdrawal of the extract and a point of injection of the lithium-containing feed;
a zone III of lithium adsorption between the point of injection of the feed and a point of withdrawal of the raffinate; and
a zone IV between the point of withdrawal of the raffinate and the point of injection of the desorbent.

Other features and advantages of the invention according to the aforementioned aspects will become apparent on reading the following description and non-limiting exemplary embodiments, with reference to the appended figures described below.

### LIST OF FIGURES

FIG. 1 depicts a simulated moving-bed lithium adsorption extraction process according to the invention, using a plurality of columns or adsorbers.

FIG. 2 depicts a simulated moving-bed lithium adsorption extraction process according to the invention, using a single column comprising a plurality of beds of solid adsorbent separated by plates.

FIG. 3 shows the calculated concentration profile along a simulated moving-bed lithium adsorption extraction column according to the invention.

### DESCRIPTION OF THE EMBODIMENTS

Embodiments of the apparatus and of the process according to the aforementioned aspects will now be described in detail. In the detailed description that follows, numerous specific details are disclosed in order to provide a deeper understanding of the apparatus and of the process. However, it will be apparent to those skilled in the art that the apparatus and process can be utilized without these specific details. In other cases, well-known characteristics have not been described in detail in order to avoid complicating the description unnecessarily.

In the present patent application, the term “to comprise” is synonymous with (means the same thing as) “to include” and “to contain”, and is inclusive or open and does not exclude other elements not stated. It is understood that the term “to comprise” includes the exclusive and closed term “to consist of”. In addition, in the present description, the terms “essentially” or “substantially” correspond to an approximation of ±30%, preferably of ±20%, very preferably of ±10%.

The present invention relates to a lithium adsorption extraction process employing a process of separation by simulated countercurrent or simulated moving-bed chromatography, which we will hereinafter designate globally by the term “SMB” process. The lithium adsorption extraction process by simulated countercurrent or simulated moving-bed chromatography of the present patent application may employ a synchronous displacement of the inlet/outlet conduits, but may also employ a non-synchronous movement of the inlet/outlet valves in a multicolumn system, the latter case being known also as VARICOL. In particular, the sequence of injection and collection points is run through over an operating cycle of the apparatus. It follows that the cycle duration refers to the time at the end of which the sequence of injection and collection points has been run through up to returning to the initial position in the apparatus. At the end of a cycle, the apparatus is once again in its initial configuration. According to one or more embodiments, a cycle comprises as many periods as there are columns or beds of solid adsorbent in the separation loop. For example, a cycle of an “SMB” process according to the invention comprising 8 columns or 8 beds of solid adsorbent is made up of 8 periods.

According to the invention, the SMB process and apparatus uses/comprises at least one column (or adsorber), the column(s) being arranged in series and employing a flow of fluids in a medium of solid particles termed solid adsorbent or granular medium in a direction of flow of the fluid(s) employed in the column(s). The fluid passing successively through the column(s) Cᵢ is referred to as main fluid to distinguish it from other, secondary fluids that can be added to the main fluid via a distribution and collection apparatus (e.g. valve systems external to the column(s)) that are generally situated at the column inlet or outlet, for example between two successive columns.

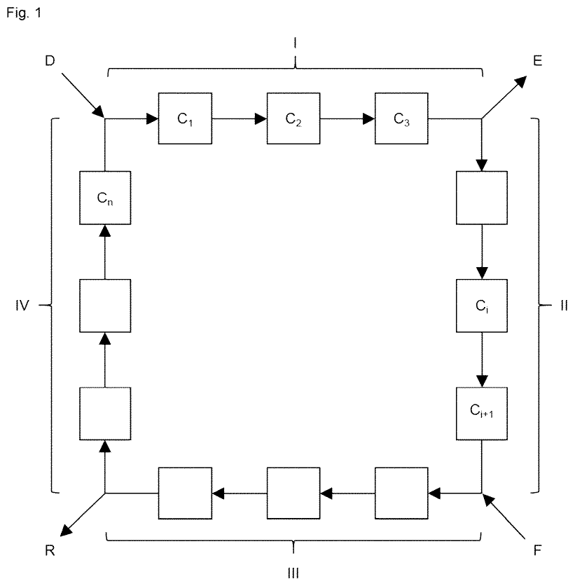

With reference to FIG. 1, according to one or more embodiments, the process and the apparatus according to the invention uses/comprises a plurality n of columns Cᵢ (i.e. from column C₁ to column Cₙ) separated by N distribution apparatuses (for the feed F and desorbent D) and collection apparatuses (for the extract E and raffinate R). Preferably, the number n of columns Cᵢ and the number N of distribution apparatuses and collection apparatuses are identical. According to one or more embodiments, n is greater than or equal to 4. According to one or more embodiments, n is between 4 and 24, preferably between 8 and 21, for example between 12 and 15. According to one or more embodiments, N is greater than or equal to 4. According to one or more embodiments, N is between 4 and 24, preferably between 8 and 21, for example between 12 and 15.

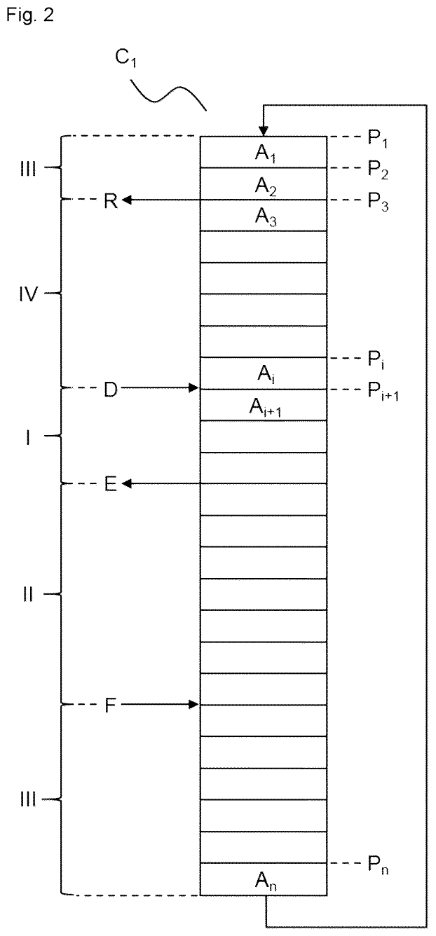

With reference to FIG. 2, the SMB process and apparatus uses/comprises a column C₁ employing the flow of fluids in a plurality of beds of solid adsorbent Ai arranged in series in a direction of flow of the fluid(s) employed in the column. The fluid passing successively through the beds of solid adsorbent Ai is referred to as main fluid to distinguish it from secondary fluids that can be added to the main fluid via a distribution and collection apparatus, also referred to as plate Pi, generally situated between two successive beds of solid adsorbent Ai.

A plate Pi comprises at least one collection zone and a system of valves for collecting the main fluid and/or injecting the secondary fluids and mixing these secondary fluids with the main fluid.

A plate also comprises at least one distribution zone for distributing the fluid resulting from the mixing of the main fluid and the secondary fluids out onto the granular bed situated immediately downstream in the direction of flow of the main fluid.

With reference to FIG. 2, a column is divided into a plurality of plates Pi and beds of solid adsorbent Ai, the plate Pi being arranged directly upstream of the bed of adsorbent Ai in the direction of the flow of the main fluid. Similarly, what is referred to as bed of adsorbent Ai+1 denotes the next bed of adsorbent situated downstream of the bed of adsorbent Ai in the direction of flow of the main fluid. In the same way, a plate Pi+1 denotes the next plate situated downstream of the plate Pi in the direction of flow of the main fluid.

According to one or more embodiments, the process and the apparatus according to the invention uses/comprises at least one separation column Cᵢ divided into n beds of solid adsorbent Aᵢ separated by N plates (defining zones between beds), it being possible for each plate to itself be divided into multiple sectors or regions, referred to as panels. Preferably, the number n of beds of solid adsorbent Aᵢ and the number N of plates Pᵢ are identical. According to one or more embodiments, n is greater than or equal to 4. According to one or more embodiments, n is between 4 and 24, preferably between 8 and 21, for example between 12 and 15. According to one or more embodiments, N is between 4 and 24, preferably between 8 and 21, for example between 12 and 15.

In the remainder of the text, what is referred to as a step denotes an operation or a group of similar operations carried out on a given stream at a certain point in the process. The process is described in its various steps taken in the order of flow of the streams or products.

The simulated moving-bed lithium adsorption extraction process according to the invention comprises the following step:
feeding one or more columns Cᵢ with at least one feed F comprising lithium and with a desorbent D and withdrawing at least one extract E and at least one raffinate R from the column Cᵢ, the column(s) Cᵢ comprising a solid adsorbent comprising at least one lithiated aluminum oxyhydroxide AlO(OH) and/or at least one lithiated aluminum hydroxide Al(OH)₃.

With reference to FIG. 1, according to one or more embodiments, the solid adsorbent is distributed in a plurality of columns Cᵢ (e.g. adsorbers).

With reference to FIG. 2, according to one or more embodiments, the solid adsorbent is distributed in beds of solid adsorbent Aᵢ of the at least one column Cᵢ, the beds of solid adsorbent Aᵢ being separated by plates Pᵢ.

According to the invention, the at least one column Cᵢ is interconnected in a closed loop, the feeding and withdrawal points of the column(s) Cᵢ being shifted over time (for example by a value corresponding to a column (e.g. adsorber) or a bed of adsorbent of a column) having a switching time, and defining a plurality of operating zones of the column(s) Cᵢ, in particular the main zones below designated numerically as follows:
a zone I of lithium desorption between a point of injection of the desorbent D and a point of withdrawal of the extract E;
a zone II of desorption of alkali metals other than lithium and/or of alkaline earth metals between the point of withdrawal of the extract E and a point of injection of the lithium-containing feed F;
a zone III of lithium adsorption between the point of injection of the feed F and a point of withdrawal of the raffinate R; and
a zone IV between the point of withdrawal of the raffinate R and the point of injection of the desorbent D.

With reference to FIG. 1, according to one or more embodiments, the feeding and withdrawal points of the columns Cᵢ are shifted over time by a value corresponding to a column Cᵢ (e.g. an adsorber).

With reference to FIG. 2, according to one or more embodiments, the feeding and withdrawal points of the at least one column Cᵢ are shifted over time by a value corresponding to a bed of adsorbent Aᵢ.

Advantageously, the process according to the invention makes it possible to separate lithium from the alkali metals, preferably sodium (Na) and potassium (K), and alkaline earth metals, preferably magnesium (Mg), calcium (Ca), and strontium (Sr), which are present in large amounts in the saline solutions treated in said extraction process. The process according to the invention also makes it possible to selectively separate lithium from other compounds such as boron and sulfates.

In particular, the process according to the invention makes it possible to produce an extract that is concentrated in lithium compared to conventional processes. A lithium concentration factor of greater than 10 between the feed and the extract is achievable by the process according to the invention, whereas conventional processes have a ceiling of 3 or 4. The countercurrent employed by the process according to the invention permits an advantageous accumulation zone for concentration of the lithium in the extract.

According to one or more embodiments, the at least one column Cᵢ comprises a plurality of columns or adsorbers interconnected in a closed loop. According to one or more embodiments, the feeding and withdrawal points of the columns Cᵢ or adsorbers are shifted over time by a value corresponding to a column or adsorber. According to one or more embodiments, the plurality of columns Cᵢ or adsorbers comprises at least 4 columns or adsorbers, preferably between 4 and 24 columns or adsorbers, preferably between 8 and 21 columns or adsorbers, for example between 12 and 15 columns or adsorbers.

According to one or more embodiments, the solid adsorbent is distributed in zones I to IV according to configurations referred to as type a/b/c/d configurations, that is to say the distribution of the solid adsorbent relative to the total amount of solid adsorbent is as follows:
a is the amount of solid adsorbent in zone I;
b is the amount of solid adsorbent in zone II;
c is the amount of solid adsorbent in zone III; and
d is the amount of solid adsorbent in zone IV,
   in which process:
a=43%±9%, preferably ±6%, very preferably ±3%;
b=29%±6%, preferably ±4%, very preferably ±2%;
c=14%±3%, preferably ±2%, very preferably ±1%; and
d=14%±3%, preferably ±2%, very preferably ±1%.

According to one or more embodiments, the at least one column Cᵢ comprises a plurality of beds of solid adsorbent Aᵢ interconnected in a closed loop and separated by plates Pᵢ, the feeding and withdrawal points in the plates Pᵢ of the column Cᵢ being shifted over time by a value corresponding to a bed of adsorbent. According to one or more embodiments, the at least one column Cᵢ comprises between 4 and 24 beds of solid adsorbent Aᵢ, preferably between 8 and 21 beds of solid adsorbent Aᵢ, for example between 8 and 21 beds of solid adsorbent Aᵢ.

According to one or more embodiments, the beds of solid adsorbent Aᵢ are distributed in zones I to IV according to configurations referred to as type a/b/c/d configurations, that is to say the distribution of the beds of solid adsorbent Aᵢ is as follows:
a is the number of beds in zone I;
b is the number of beds in zone II;
c is the number of beds in zone III; and
d is the number of beds in zone IV,
   in which process:
a=(t*0.43)*(1±0.20, preferably 1±0.10, very preferably 1±0.05);
b=(t*0.29)*(1±0.20, preferably 1±0.10, very preferably 1±0.05);
C=(t*0.14)*(1±0.20, preferably 1±0.10, very preferably 1±0.05); and
d=(t*0.14)*(1±0.20, preferably 1±0.10, very preferably 1±0.05),
   in which process t is a natural integer between 4 and 24, preferably between 8 and 21, such as between 12 and 15.

According to one or more embodiments, the temperature is adjusted such that the solid adsorbent is maintained at a temperature of between 0° C. and 120° C. and preferably between 5° C. and 100° C., more preferably between 15° C. and 80° C., very preferably between 40° C. and 80° C., in particular in order to promote accelerated penetration of the solid adsorbent.

Advantageously, the pressure is adjusted such that the liquid phase is maintained at all points of the process according to the invention. According to one or more embodiments, the pressure in the solid adsorbent is between 0.09 MPa and 5 MPa, preferably between 0.095 MPa and 3.5 MPa, preferably between 0.1 MPa and 2.5 MPa.

According to one or more embodiments, a portion of the extract E or a stream obtained by concentrating and/or purifying said extract is fed to zone II, preferably to a central portion of zone II, very preferably substantially in the middle of zone II, in particular to improve the concentrating of the extract. In the present patent application, the term “substantially in the middle of zone II”, zone II comprising an amount X of solid adsorbent, corresponds to a position arranged between 0.35*X and 0.65*X of solid adsorbent, preferably between 0.40*X and 0.60*X of solid adsorbent, very preferably between 0.45*X and 0.55*X of solid adsorbent.

According to one or more embodiments, at least 1% of the extract E or a stream obtained by concentrating and/or purifying said extract, preferably at least 5% of the extract E or a stream obtained by concentrating and/or purifying said extract, very preferably at least 10% of the extract E or a stream obtained by concentrating and/or purifying said extract, is fed to zone II. According to one or more embodiments, between 5% and 20% of the extract E or a stream obtained by concentrating and/or purifying said extract is fed to zone II.

According to one or more embodiments, the cycle duration is at least 20 minutes, preferably at least 40 minutes, such as between 1 hour and 10 hours. Preferably, the cycle duration employed is between 2 hours and 8 hours. The cycle duration corresponds to the switching time ST (period between two successive switchings of the feeds/extractions) multiplied by the total number of injection/withdrawal points, such as the total number of columns Cᵢ used (see example in FIG. 1) or beds of solid adsorbent Aᵢ used (see example in FIG. 2).

According to one or more embodiments, the recycle rate (i.e. ratio of the average recycle flow rate (average flow rate of the zones weighted by the number of columns or beds of solid adsorbent per zone) to the feed flow rate) is between 2 and 12, preferably between 3 and 9, very preferably between 5 and 8.

According to one or more embodiments, the ratio of the volume flow rate of the desorbent to the volume flow rate of the feed is less than 1, preferably less than 0.5, preferably less than 0.2, very preferably less than 0.1. According to one or more embodiments, the ratio of the volume flow rate of the desorbent to the volume flow rate of the feed is between 0.01 and 1.0, preferably between 0.02 and 0.5, very preferably between 0.06 and 0.1.

According to one or more embodiments, the process according to the invention advantageously comprises a step of activating the solid adsorbent. Said activation step activates the intended sites of selective adsorption of lithium. Preferably, said activation step is advantageously carried out by passage of an activation solution selected from water and a solution of a lithium salt having a concentration of between 0.001 mol/L and 0.1 mol/L, preferably between 0.001 mol/L and 0.05 mol/L, and preferably between 0.01 and 0.04 mol/L. The lithium salt used in solution in said activation step is preferably selected from lithium chloride (LiCl), lithium nitrate, and lithium bromide. The lithium salt used in solution in said activation step is very preferably lithium chloride (LiCl). According to one or more embodiments, said activation step is carried out at a temperature of between 0° C. and 90° C., preferably between 10° C. and 60° C., preferably between 10° C. and 30° C., with a residence time of said activation solution in the column preferably of between 0.03 and 10 h, preferably between 0.06 and 1 h. According to one or more embodiments, the volume of activation solution is between 1 and 30 times, preferably between 2 and 20 times, the total volume of adsorbent.

The simulated moving-bed lithium adsorption extraction apparatus comprises the following elements:
at least one column (Cᵢ) suitable for being fed with at least one feed comprising lithium and with a desorbent and for the withdrawal of at least one extract and at least one raffinate from the column (Cᵢ), the at least one column (Cᵢ) comprising a solid adsorbent comprising at least one lithiated aluminum oxyhydroxide AlO(OH) and/or at least one lithiated aluminum hydroxide Al(OH)₃, the at least one column (Cᵢ) being interconnected in a closed loop, the feeding and withdrawal points of the at least one column (Cᵢ) being shifted over time by a value corresponding to a predetermined amount of solid adsorbent having a switching time and a plurality of zones I, II, III and IV as defined above being defined.

According to one or more embodiments, the feeding and withdrawal points of the at least one column (Cᵢ) are synchronously offset.

According to one or more embodiments, the feeding and withdrawal points of the at least one column (Cᵢ) are asynchronously offset. In this case, the cycle duration refers to the time at the end of which the sequence of injection and collection points has been run through up to returning to the initial position in the apparatus. The amount of solid adsorbent contained in each of the zones I, II, III and IV as defined above is then calculated as being the average amount of solid adsorbent respectively contained in each of the zones over the duration of the cycle. In the same way, the number of beds in each of the zones I, II, III and IV as defined above is calculated as being the average number of adsorbent beds respectively contained in each of the zones over the duration of the cycle, it being possible for this value to be a non-integer.

According to one or more embodiments, the feed comprises and preferably consists of a (saline) solution containing lithium and which may or may not be saturated with salts, such as a brine.

According to one or more embodiments, the feed comprises at least one of the following elements: Na, K, Rb, Cs, Mg, Ca, Sr, Ba, F, Cl, Br, I, SO₄, CO₃, NO₃, B, and HCO₃.

Said feed may be any natural or concentrated saline solution or one resulting from a lithium extraction or transformation process. For example, said saline solution used in the extraction process according to the invention may advantageously be selected from brines from salt lakes or geothermal sources, brines subjected to evaporation to obtain brines concentrated in lithium, seawater, effluents from lithium chloride or hydroxide production plants, and effluents from processes for extracting lithium from minerals.

According to one or more embodiments, the feed comprises at least 0.1 g/L by weight of the element lithium, preferably in the form of LiCl, relative to the total weight of the feed. According to one or more embodiments, the feed comprises between 0.1 g/L and 1 g/L of the element lithium, preferably in the form of LiCl, relative to the total weight of the feed.

According to one or more embodiments, the desorbent is selected from the group consisting of water, lithiated water, and brine, preferably water. According to one or more embodiments, the desorbent comprises between 0 g/L and 1 g/L of the element lithium, preferably in the form of LiCl, relative to the total weight of the desorbent. According to one or more embodiments, the desorbent comprises less than 0.05 g/L of the element lithium, preferably less than 0.01 g/L of the element lithium, relative to the total weight of the desorbent.

According to one or more embodiments, the at least one lithiated aluminum oxyhydroxide AlO(OH) comprises lithiated boehmite. According to one or more embodiments, the at least one lithiated aluminum oxyhydroxide AlO(OH) comprises at least 60% by weight, preferably at least 80% by weight, of lithiated boehmite, relative to the total weight of the at least one lithiated aluminum oxyhydroxide AlO(OH). According to one or more embodiments, the at least one lithiated aluminum oxyhydroxide AlO(OH) consists of lithiated boehmite.

According to one or more embodiments, the at least one lithiated aluminum hydroxide Al(OH)₃ comprises lithiated bayerite. According to one or more embodiments, the at least one lithiated aluminum hydroxide Al(OH)₃ comprises at least 60% by weight, preferably at least 80% by weight, of lithiated bayerite, relative to the total weight of the at least one lithiated aluminum hydroxide Al(OH)₃. According to one or more embodiments, the at least one lithiated aluminum hydroxide Al(OH)₃ consists of lithiated bayerite.

According to one or more embodiments, the solid adsorbent comprises at least 0.1% by weight of the element lithium (preferably in the form of LiCl), preferably at least 1% by weight, very preferably at least 1.5% by weight, relative to the total weight of the solid adsorbent. According to one or more embodiments, the solid adsorbent comprises between 0.1% by weight and 5% by weight of the element lithium (preferably in the form of LiCl), preferably between 1% by weight and 4% by weight, very preferably between 1.5% by weight and 3% by weight, relative to the total weight of the solid adsorbent.

According to one or more embodiments, the solid adsorbent comprises and preferably consists of a solid material of formula (LiCl)ₓ·2Al(OH)₃·nH₂O, where n is between 0.01 and 10 and x is between 0.4 and 1. According to one or more embodiments, n is between 0.1 and 5, preferably between 0.1 and 1, very preferably between 0.1 and 0.5.

According to one or more embodiments, the solid adsorbent has a specific surface area characterized by nitrogen adsorption according to the BET method of between 1 m²/g and 30 m²/g, preferably between 1 m²/g and 20 m²/g.

According to one or more embodiments, the solid adsorbent is provided in the form of beads or extrudates of cylindrical, hollow cylinder, cartwheel, trilobe or multilobe shape or any other geometric shape used by a person skilled in the art. According to one or more embodiments, the solid adsorbent is in the form of beads having an average diameter of between 0.1 and 1.5 mm, preferably between 0.1 and 1 mm, more preferably between 0.1 and 0.3 mm. According to one or more embodiments, the solid adsorbent is in the form of extrudates having a diameter of between 0.15 and 5 mm, preferably between 0.2 and 3 mm, more preferably between 0.25 and 1.8 mm.

The solid adsorbent material is characterized by the following techniques: nitrogen adsorption for determining the specific surface area according to the BET method (e.g. standard ASTM D 3663-7); X-ray fluorescence for elemental analysis. The average diameter of the extrudates is measured by optical measurement of at least 10 extrudates, preferably at least 50 extrudates. For example, when the solid adsorbent is in the form of beads, the number-average diameter of the solid adsorbent is estimated via a particle size distribution analysis of a sample of at least 50 adsorbent beads by imaging according to standard ISO 13322-2:2006, using a carousel to pass the sample in front of the camera lens. The number-average diameter is then calculated from the particle size distribution by applying standard ISO 9276-2:2001.

### EXAMPLES

### Example 1 (Inventive): Separation of a Brine with Simulated Countercurrent

The process according to the invention is applied for the purification and separation of a lithium brine of the following composition:
0.4 g/L of the element lithium;
−110 g/L of the element chlorine;
−70 g/L of the element sodium.

The solid adsorbent considered for the separation is a lithiated bayerite.

The process uses a column C₁ comprising 21 beds of solid adsorbent Aᵢ distributed as follows:
9 beds in zone 1;
6 beds in zone 2;
3 beds in zone 3;
3 beds in zone 4.

The separation takes place at 20° C. The desorbent is water that does not contain the element lithium. The desorbent/feed flow ratio is equal to 0.08 and the average recycle rate is 7.3. The surface velocity in zone 3 is 0.5 cm/s.

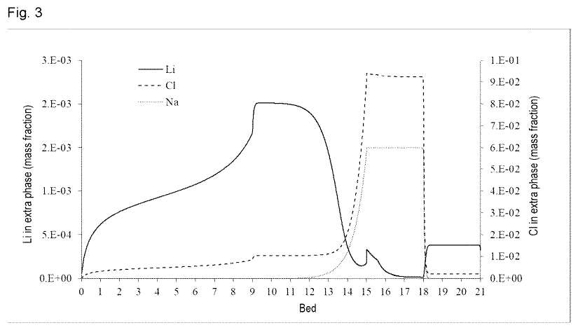

Process performances are calculated by simulation. Thermodynamic and material transfer data had been previously obtained by penetration tests, as commonly practiced by those skilled in the art. The calculated concentration profile along the simulated moving bed is shown in FIG. 3.

The results indicate a concentration in the extract of 4.4 g/L, or a concentration factor equal to 11. This high concentration greatly reduces the equipment and energy consumption necessary to evaporate the water in the downstream stages of the process.

Moreover, the lithium purity, defined as the ratio of the mass of lithium and the cumulative mass of sodium and lithium, is 99.9%.

### Example 2 (Non-Inventive): Separation of a Brine without Simulated Countercurrent

In example 2, a brine identical to example 1 is separated by an adsorption process at 20° C. on a lithiated bayerite identical to example 1. However, in this case the employed process is operated in a batchwise manner and without employing a simulated countercurrent.

The end product has an end concentration equal to 1.2 g/L of the element lithium. The concentration factor obtained is equal to 3 and is significantly lower than in the case of simulated countercurrent.

The process according to the invention allows the production of a stream that is much more concentrated than that of a standard batchwise adsorption process.

1. A simulated moving-bed lithium adsorption extraction process comprising:
feeding at least one column (Cᵢ) with at least one feed (F) comprising lithium and with a desorbent (D), and withdrawing at least one extract (E) and at least one raffinate (R) from the column (Cᵢ), the at least one column (Cᵢ) comprising a solid adsorbent comprising at least one lithiated aluminum oxyhydroxide AlO(OH) and/or at least one lithiated aluminum hydroxide Al(OH)₃, the at least one column (Cᵢ) being interconnected in a closed loop, the feeding and withdrawal points of the at least one column (Cᵢ) being shifted over time by a value corresponding to a predetermined amount of solid adsorbent having a switching time, and defining a plurality of operating zones of the column (Cᵢ), said plurality of operating zones comprising:
a zone I of lithium desorption between a point of injection of the desorbent and a point of withdrawal of the extract;
a zone II of desorption of alkali metals other than lithium and/or of alkaline earth metals between the point of withdrawal of the extract and a point of injection of the lithium-containing feed;
a zone III of lithium adsorption between the point of injection of the feed and a point of withdrawal of the raffinate; and
a zone IV between the point of withdrawal of the raffinate and the point of injection of the desorbent.

2. The process as claimed in claim 1, wherein the at least one column (Cᵢ) comprises a plurality of columns (Cᵢ) or adsorbers interconnected in a closed loop, the feeding and withdrawal points of the columns (Cᵢ) or adsorbers being shifted over time by a value corresponding to a column (Cᵢ) or an adsorber.

3. The process as claimed in claim 1, wherein the plurality of columns (Cᵢ) or adsorbers comprises at least 4 columns or adsorbers.

4. The process as claimed in claim 1, wherein the solid adsorbent is distributed in zones I to IV according to configurations referred to as type a/b/c/d configurations, that is to say the distribution of the solid adsorbent relative to the total amount of solid adsorbent is as follows:
a is the amount of solid adsorbent in zone I;
b is the amount of solid adsorbent in zone II;
c is the amount of solid adsorbent in zone III; and
d is the amount of solid adsorbent in zone IV,
in which process:
$$- a = 43 \% \pm 9 \% ;$$
$$- b = 29 \% \pm 6 \% ;$$
$$- c = 14 \% \pm 3 \% ; and$$
$$- d = 14 \% \pm 3 \% .$$

5. The process as claimed in claim 1, the at least one column (Cᵢ) comprising a plurality of beds of solid adsorbent (Aᵢ) interconnected in a closed loop and separated by plates (Pᵢ), the feeding and withdrawal points in the plates (Pᵢ) of the column (Cᵢ) being shifted over time by a value corresponding to a bed of adsorbent.

6. The process as claimed in claim 5, wherein the at least one column (Cᵢ) comprises between 4 and 24 beds of solid adsorbent (Aᵢ).

7. The process as claimed in claim 5, wherein the beds of solid adsorbent (Aᵢ) are distributed in zones I to IV according to configurations referred to as type a/b/c/d configurations, that is to say the distribution of the beds of solid adsorbent (Aᵢ) is as follows:
a is the number of beds in zone I;
b is the number of beds in zone II;
c is the number of beds in zone III; and
d is the number of beds in zone IV,
in which process:
$$- a = ( t * 0.43 ) * ( 1 \pm 0.20 ) ;$$
$$- b = ( t * 0.29 ) * ( 1 \pm 0.20 ) ;$$
$$- c = ( t * 0.14 ) * ( 1 \pm 0.20 ) ; and$$
$$- d = ( t * 0.14 ) * ( 1 \pm 0.20 ) ,$$
in which process t is a natural integer between 4 and 24.

8. The process as claimed in claim 1, wherein a portion of the extract (E) or a stream obtained by concentrating and/or purifying said extract (E) is fed to zone II.

9. The process as claimed in claim 1, wherein the solid adsorbent comprises lithiated bayerite and/or lithiated boehmite.

10. The process as claimed in claim 1, wherein the solid adsorbent comprises between 0.1% by weight and 5% by weight of the element lithium relative to the total weight of the solid adsorbent.

11. The process as claimed in claim 1, wherein the solid adsorbent comprises a solid material of formula (LiCl)ₓ·2Al(OH)₃·nH2O, where n is between 0.01 and 10 and x is between 0.4 and 1.

12. The process as claimed in claim 1, wherein the feed (F) comprises at least 0.1 g/L by weight of the element lithium relative to the total weight of the feed.

13. The process as claimed in claim 1, wherein the steps of the process are carried out at a temperature of between 0° C. and 120° C.

14. The process as claimed in claim 1, wherein the ratio of the volume flow rate of the desorbent (D) to the volume flow rate of the feed (F) is less than 1.

15. A simulated moving-bed lithium adsorption extraction apparatus comprising:
at least one column (Cᵢ) suitable for being fed with at least one feed (F) comprising lithium and with a desorbent (D) and for the withdrawal of at least one extract (E) and at least one raffinate (R) from the column (Cᵢ), the at least one column (Cᵢ) comprising a solid adsorbent comprising at least one lithiated aluminum oxyhydroxide AlO(OH) and/or at least one lithiated aluminum hydroxide Al(OH)₃, the at least one column (Cᵢ) being interconnected in a closed loop, the feeding and withdrawal points of the at least one column (Cᵢ) being shifted over time by a value corresponding to a predetermined amount of solid adsorbent having a switching time, and defining a plurality of operating zones of the column (Cᵢ), said plurality of operating zones comprising:
a zone I of lithium desorption between a point of injection of the desorbent and a point of withdrawal of the extract;
a zone II of desorption of alkali metals other than lithium and/or of alkaline earth metals between the point of withdrawal of the extract and a point of injection of the lithium-containing feed;
a zone III of lithium adsorption between the point of injection of the feed and a point of withdrawal of the raffinate; and
a zone IV between the point of withdrawal of the raffinate and the point of injection of the desorbent.
